(19) United States
(12) Patent Application Publication
(10) Pub. No.: US 2017/0107900 A1
(43) Pub. Date: Apr. 20, 2017

(54) PACKAGE-STORAGE TYPE ENGINE GENERATOR

(71) Applicant: YANMAR CO., LTD., Osaka-shi (JP)

(72) Inventors: Ruriko Terada, Osaka-shi (JP); Tatsuya Kawano, Osaka-shi (JP); Akihiro Nagao, Osaka-shi (JP); Takahiro Kyakuno, Osaka-shi (JP); Satoshi Abe, Osaka-shi (JP)

(21) Appl. No.: 15/128,240

(22) PCT Filed: Feb. 13, 2015
(86) PCT No.: PCT/JP2015/053898

§ 371 Date: Sep. 22, 2016

(30) Foreign Application Priority Data
Mar. 26, 2014 (JP) 2014-063049

(51) Int. Cl. F02B 63/04; F01P 11/02

(52) U.S. Cl. CPC F02B 63/044; F01P 11/029

(57) ABSTRACT

A package-storage type engine generator includes a package partitioned into an upper section and a lower section, an engine and a generator both disposed in the lower section, and a radiator and a radiator fan both disposed in the upper section. The radiator is horizontally disposed so that heat-transfer surfaces of the radiator are horizontal, and the radiator fan is disposed above the radiator. Vent holes are formed in an outer plate of the upper section so as to be located lower than a position of the radiator.

### TECHNICAL FIELD

The present invention relates to a package-storage type engine generator that is adopted to a cogeneration system and the like.

### BACKGROUND ART

Conventionally, in a package-storage type engine generator adopted to a cogeneration system and the like, peripheral devices such as a radiator and a radiator fan are stored in the package, apart from an engine and a generator.

Patent Document 1 discloses a configuration in which a radiator chamber is disposed in the upper portion of the package. A radiator fan is disposed in the upper portion of the radiator chamber, while a radiator is disposed on a side portion of the radiator chamber. In such a conventional configuration shown in Patent Document 1, the radiator fins are exposed to the outside.

### PRIOR ART DOCUMENTS

### Patent Document

[Patent Document 1] Japanese Patent No. 5134428

### SUMMARY OF INVENTION

### Problem to Be Solved by Invention

However, in the conventional configuration in which the radiator fins are exposed to the outside, the fins may be damaged by hailstones or other falling matters, which results in degradation in appearance.

The present invention was made in consideration of the above circumstances. An object of the present invention is to provide a package-storage type engine generator having a configuration in which a radiator is disposed so that radiator fins are not exposed to the outside.

### Means for Solving Problem

In order to resolve the above problems, a package-storage type engine generator of the present invention includes: a package partitioned into an upper section and a lower section; an engine and a generator both disposed in the lower section; and a radiator and a radiator fan both disposed in the upper section. The radiator is horizontally disposed in the upper section so that heat-transfer surfaces of the radiator are horizontal, and the radiator fan is disposed above the radiator. Vent holes are formed in an outer plate of the upper section so as to be located lower than a position of the radiator.

With the above configuration, the radiator is horizontally disposed in the upper section, and the radiator fan is horizontally disposed above the radiator. Since the radiator fan is disposed above the heat-transfer surfaces of the radiator, it is possible to avoid exposure of the radiator fins to the outside. Thus, it is possible to prevent the radiator fins from being damaged by hailstones or other falling matters, thereby preventing the appearance from being degraded.

Also, in the above-described package-storage type engine generator, the outer plate and supports that make up of the package may be dividable into upper parts and lower parts corresponding to the upper section and the lower section. The radiator and the radiator fan may be supported by the supports in the upper section.

With the above configuration, since the package-storage type engine generator is dividable into the upper section and the lower section, the package-storage type engine generator may be easily carried into a building or an apartment building. Since the size of the package-storage type engine generator can be reduced in the height direction by dividing it, for example, into the upper section and the lower section, it is easy to carry the package-storage type engine generator into a building or an apartment building by an elevator.

### Effects of Invention

A package-storage type engine generator of the present invention has a configuration in which radiator fins are not exposed to the outside, which provides an effect to prevent its appearance being degraded due to damage of the radiator fins by hailstones or other falling matters.

### BRIEF DESCRIPTION OF DRAWINGS

FIG. 1 are front views of a cogeneration system according to an embodiment. FIG. 1(a) is an internal structure view thereof, while FIG. 1(b) is an external view thereof.

FIG. 2 are back views of the cogeneration system according to the embodiment. FIG. 2(a) is an internal structure view thereof, while FIG. 2(b) is an external view thereof.

FIG. 3 are right side views of the cogeneration system according to the embodiment. FIG. 3(a) is an internal structure view thereof, while FIG. 3(b) is an external view thereof.

FIG. 4 are left side views of the cogeneration system according to the embodiment. FIG. 4(a) is an internal structure view thereof, while FIG. 4(b) is an external view thereof.

FIG. 5 are plan views of the cogeneration system according to the embodiment. FIG. 5(a) is an internal structure view thereof, and FIG. 5(b) is an external view thereof.

FIG. 6 is a perspective view of an upper structure of the cogeneration system according to the embodiment.

### MODES FOR CARRYING OUT INVENTION

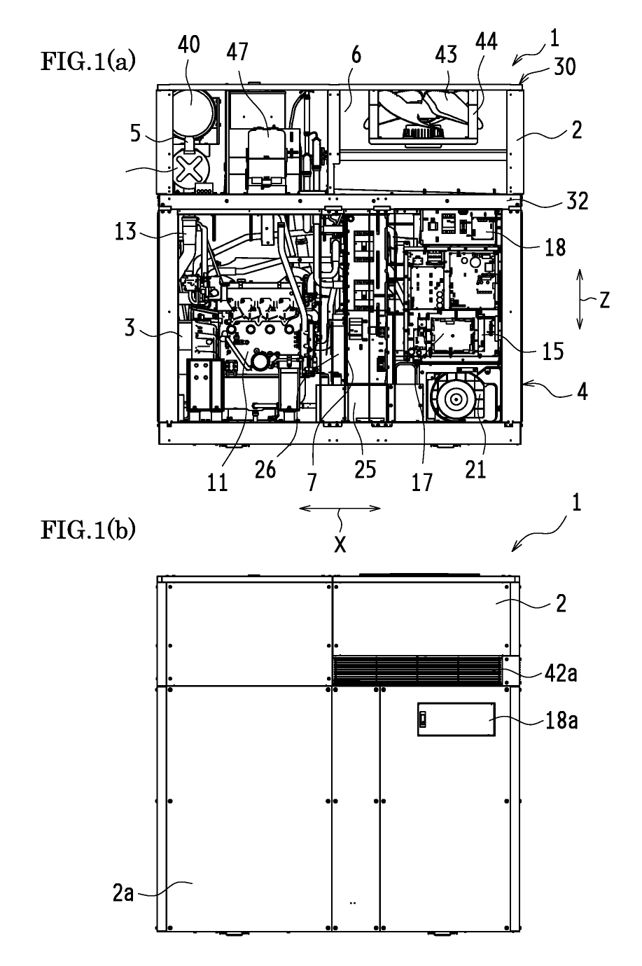

Hereinafter, an embodiment of the present invention will be described with reference to the appended drawings. FIGS. 1 to 5 are respectively front views, back views, right side views, left side views and plan views of a cogeneration system 1 according to this embodiment. FIGS. 1(a) to 5(a) are internal structure views thereof, while FIGS. 1(b) to 5(b) are external views thereof.

In this embodiment, description will be given on a case in which the present invention is applied to the cogeneration system 1. The cogeneration system 1 is a system configured to: electrically connect a commercial power system of an external commercial power supply and a generation power system of a generator 12 to a power transmission system for power consuming devices (load) so as to cover a demand power of the load; and recover waste heat accompanying power generation so as to use the recovered waste heat. That is, the cogeneration system 1 has, in addition to a power generation function outputting a power generated by the generator 12 driven by an engine 11, a function that recovers, by an engine waste heat recovery unit 23, waste heat of cooling water that is circulated by an engine coolant circuit and that is heated by heat exchange with waste heat of the engine 11 (i.e., in this embodiment, the function that recovers the waste heat of the cooling water for use in supplying hot-water).

As shown in FIGS. 1 to 5, the cogeneration system 1 according to this embodiment includes a package 2 as a housing formed in a substantially rectangular parallelepiped shape. The package 2 can be divided into an upper section and a lower section by an upper/lower partition member 32 that is disposed above the middle of the package 2 in the vertical direction Z and that partitions the package 2 into the upper section and the lower section. On the lower side (in the lower section) of the package 2, an engine chamber 3 and a device housing chamber 4 are disposed, while on the upper side (in the upper section), an intake chamber 5 and a radiator/exhaust chamber 6 are disposed. A partition wall 7 partitions the lower section into the left section and the right section as the engine chamber 3 and the device housing chamber 4.

(Engine Chamber)

The engine chamber 3 is disposed on one side of the package 2 in the long-side direction X (in this embodiment, on the left side in FIG. 1(a) and on the right side in FIG. 1(b)). In the engine chamber 3, the generator 12 is disposed on one side in the long-side direction X relative to the engine 11 as the center. The generator 12 is driven by rotary drive of the engine 11.

As the engine 11, for example, a gas engine is adopted. The engine 11 is started by mixing fuel gas with air. Then, the generator 12, which is disposed consecutively with the engine 11, is driven by the rotary drive of the engine 11.

As shown in FIGS. 1(a), 2(a) and 4(a), in the upper periphery of the engine 11, the following are disposed: pipes such as the engine coolant circuit that cools the engine by circulating the cooling water;

and an exhaust gas heat exchanger 14 that exchanges heat between exhaust gas discharged from the engine 11 and the cooling water from the engine 11.

(Device Housing Chamber)

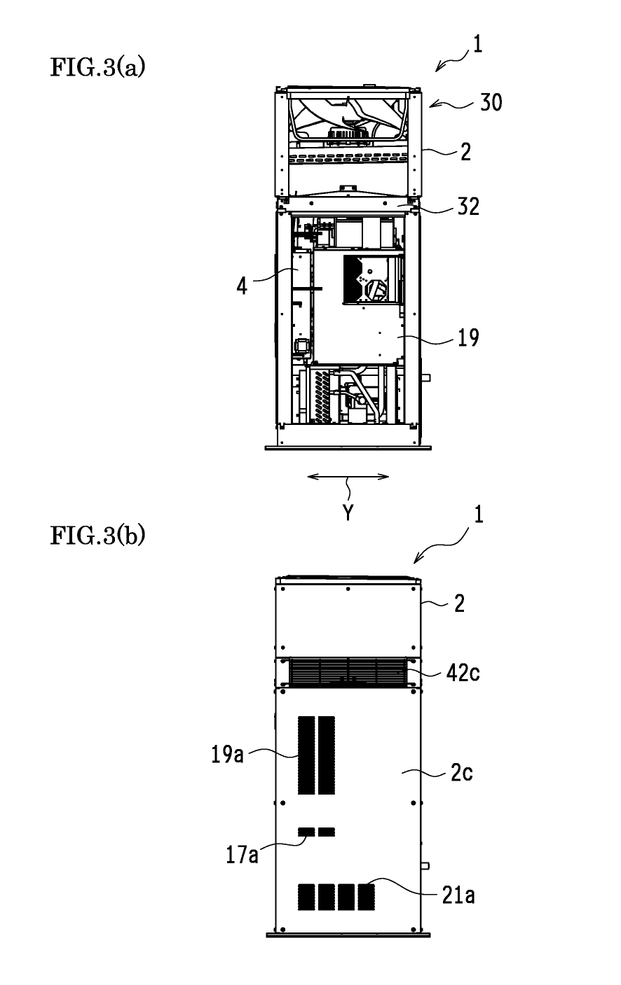

The device housing chamber 4 is disposed on the other side of the package 2 in the long-side direction X (on the right side in FIG. 1(a)). In the device housing chamber 4, a controller box 17 and an operation unit 18 are disposed on one side of the package 2 in the short-side direction Y (in this embodiment, the front side) (see FIG. 1(a)). The controller box 17 includes a controller 15 that controls engine drive devices and engine waste heat recovery devices. The operation unit 18 operates electrical devices. Also, in a side surface 2c of the package 2, a controller box ventilation hole 17a is formed at a position corresponding to the controller box 17 so as to introduce the outside air to the controller box 17 (see FIG. 3(b)). In a front surface 2a of the package 2, the operation unit door 18a is disposed at a position corresponding to the operation unit 18 so as to operate the operation unit 18 (see FIG. 1(b)).

An inverter 19 is disposed on the other side of the package 2 in the long-side direction X (see FIG. 3(a)). Also, in the side surface 2c of the package 2, an inverter ventilation hole 19a is formed at a position corresponding to the inverter 19 so as to introduce the outside air to the inverter 19 (see FIG. 3(b)).

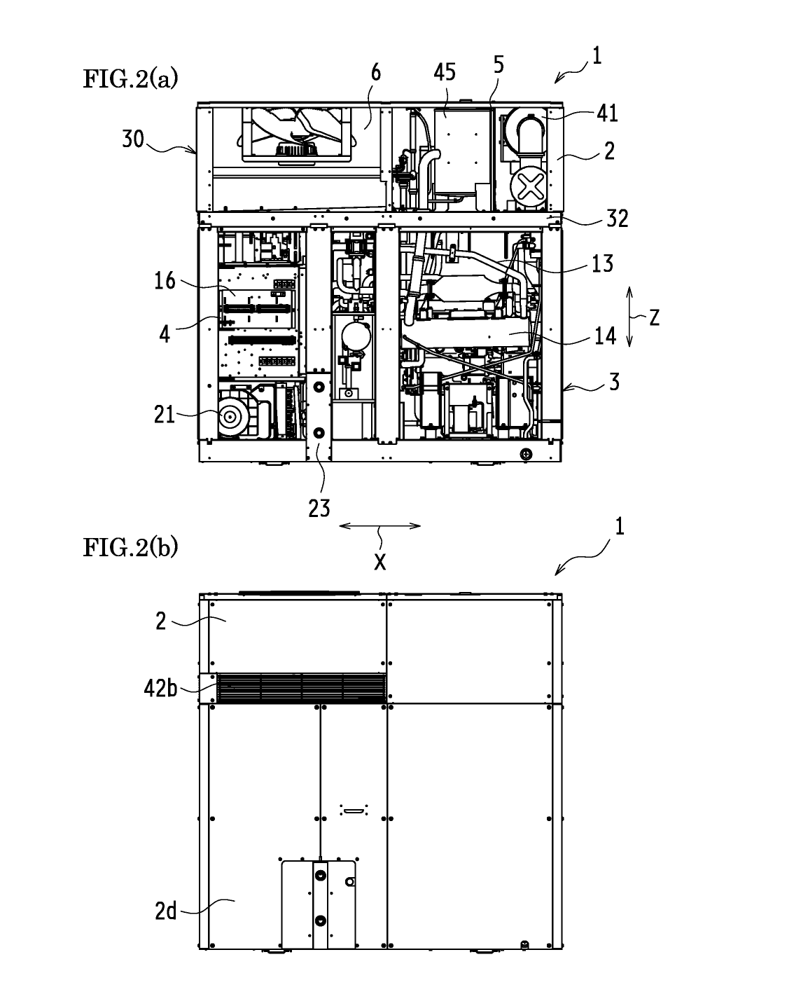

A terminal unit 16 (terminal block) is disposed on the other side of the package 2 in the short-side direction Y so as to wire the electrical devices. A ventilation fan 21 is disposed in a lower portion on the other side of the package 2 in the long-side direction X so as to suck the outside air into the engine chamber 3 (see FIG. 2(a)). Also, in the side surface 2c of the package 2, an engine chamber ventilation hole 21a is formed so as to introduce the outside air into the engine chamber 3 (see FIG. 3(b)).

A sub-oil tank 25 and a reserve oil tank 26 are disposed in the middle of the package 2 in the long-side direction X and on the one side of the package 2 in the short-side direction Y (see FIG. 1(a)). Also, the engine waste heat recovery unit 23 is disposed in the middle of the package 2 in the long-side direction X and on the other side of the package 2 in the short-side direction Y so as to recover waste heat of the cooling water that flows from the exhaust gas heat exchanger 14 (see FIG. 2(a)).

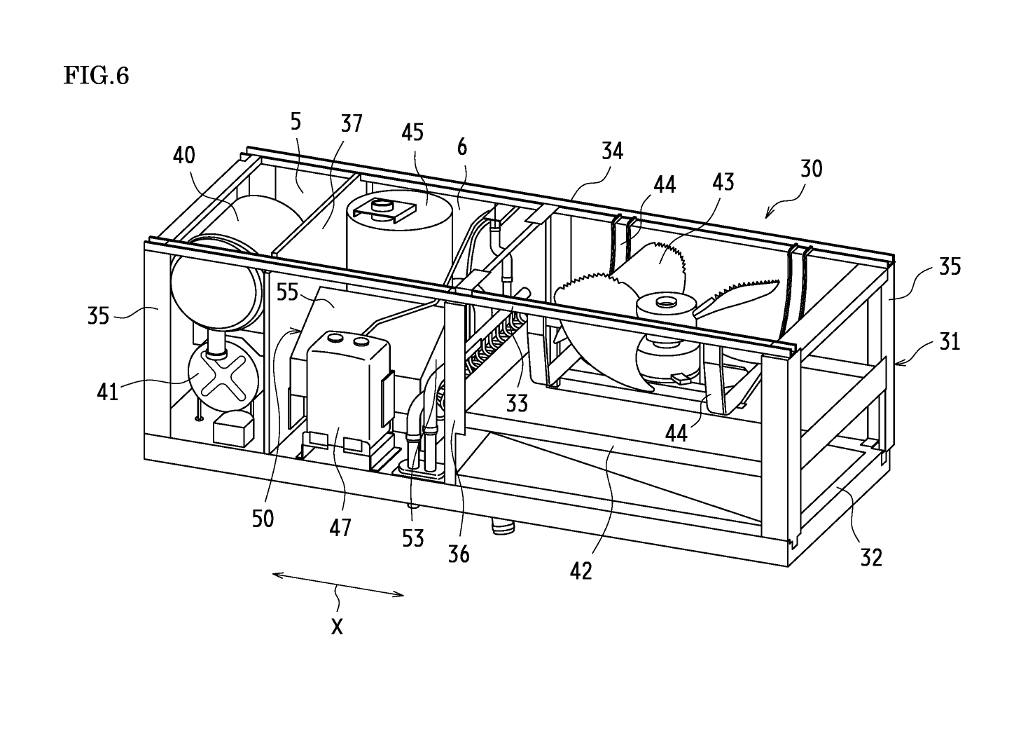

Here, description will be given on an upper structure 30 having the intake chamber 5 and the radiator/exhaust chamber 6. FIG. 6 is a perspective view of the upper structure 30.

The upper structure 30 includes a frame body 31 in a rectangular parallelepiped shape. The frame body 31 includes: the upper/lower partition member 32 made of sheet metal constituting a floorboard; portal support members 35 and 35 disposed in a standing manner on both sides of the upper/lower partition member 32 in the long-side direction X; a front horizontal member 33 and a rear horizontal member 34 bridged between the left and right support members 35 and 35; and an intermediate support 36 disposed in the middle of the support members 35 and 35. The intake chamber 5 and the radiator/exhaust chamber 6 are formed and partitioned by, for example, a partition wall 37 made of a metal plate.

(Intake Chamber)

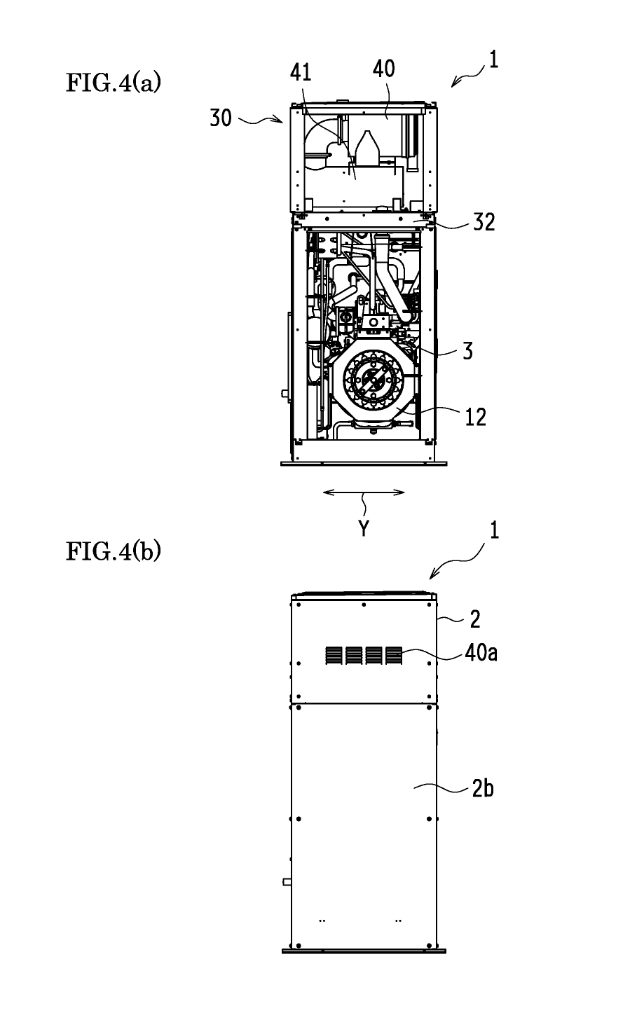

An air cleaner 40, which purifies air sucked from the outside, is disposed in an upper portion of the intake chamber 5, and an intake silencer 41, which reduces noise of the engine 11, is disposed in a lower portion thereof (see FIGS. 1(a), 2(a), 4(a) and 5(a)). In a side surface 2b of the package 2, an engine intake port 40a is formed at a position corresponding to the air cleaner 40 so as to introduce the outside air to the air cleaner 40 (see FIG. 4(b)).

(Radiator/Exhaust Chamber)

The radiator/exhaust chamber 6 is located over the substantially overall device housing chamber 4 and a part of the engine chamber 3. In the radiator/exhaust chamber 6, a radiator 42 is horizontally disposed in the middle portion in the vertical direction Z so as to radiate the waste heat of the cooling water that is discharged from the exhaust gas heat exchanger 14. The radiator 42 is provided as a part of the engine coolant circuit. The four corners of the radiator 42 are supported in a hanging manner by the support member 35 and the intermediate support 36. In the front surface 2a, a back surface 2b and the side surface 2c of the package 2, radiator ventilation holes 42a, 42b and 42c are respectively formed at respective positions corresponding to the radiator 42 (in particular, positions slightly lower than the radiator 42) so as to introduce the outside air to the radiator 42 (see FIGS. 1(b), 2(b) and 3(b)).

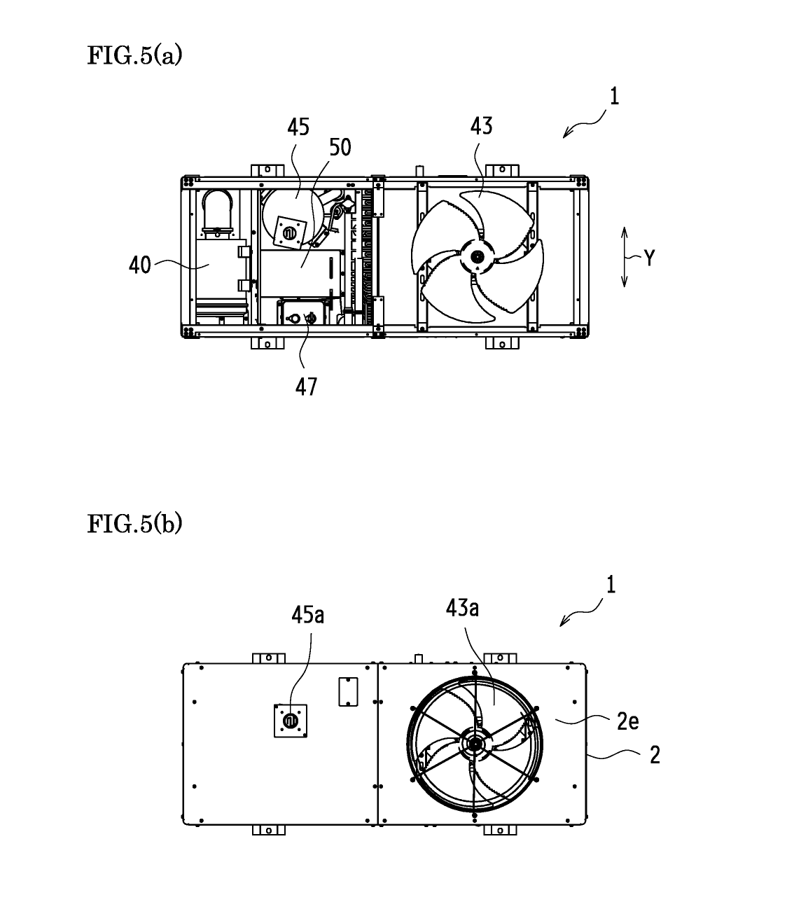

Above the radiator 42, a radiator fan 43 is disposed. The radiator fan 43 is driven and controlled by the controller 15 to discharge the air in the radiator/exhaust chamber 6 to the outside, thereby radiating the heat of the radiator 42. The radiator fan 43 is attached to the front horizontal member 33 and the rear horizontal member 34 with being secured to U-shaped frame members 44 that are attached to the upper/lower partition member 32. In a top surface 2e of the package 2, a ventilation outlet 43a is formed at a position corresponding to the radiator fan 43 (see FIG. 5(b)).

Also, a reserve coolant tank 47 is disposed on the one side of the package 2 in the short-side direction Y so as to supply the cooling water to an engine coolant circuit 20 (see FIGS. 1(a) and 5(a)). An exhaust silencer 45 is disposed on the other side of the package 2 in the short-side direction Y so as to reduce exhaust noise when exhaust gas is discharged to the outside (see FIGS. 1(a), 2(a) and 5(a)). In the top surface 2e of the package 2, an exhaust outlet opening 45a is formed at a position corresponding to the exhaust silencer 45 (see FIG. 5(b)).

On the upper/lower partition member 32, there is a space between the reserve coolant tank 47 and the exhaust silencer 45. In this space, a ventilation hole is formed so as to communicate the engine chamber 3 with the radiator/exhaust chamber 6. The ventilation hole is disposed in a position displaced from the radiator fan 43 in the long-side direction of the package. A ventilation hood 50 is disposed above the ventilation hole.

The cogeneration system 1 according to this embodiment has the configuration as described above. Next, further details of the configuration of the radiator/exhaust chamber 6 will be described with reference to FIG. 6.

In the cogeneration system 1, the radiator 42 is horizontally disposed in the radiator/exhaust chamber 6. Here, the horizontal disposition of the radiator is defined as described below. The radiator has a structure in which a large number of tubes are arranged, with being surrounded by fins for heat radiation. These tubes and fins constitute a radiator core. The radiator core has relatively large size in two axial directions out of the three axial directions orthogonal to each other, and the tubes are arranged along a face including the two axial direction. The other one axial direction is a thickness direction of the radiator core, whose thickness is relatively small. The horizontal disposition of the radiator means that the radiator is disposed so that the thickness direction of the radiator core is the vertical direction.

Also, the tubes and the fins of the radiator are exposed on both faces orthogonal to the thickness direction of the radiator core. Thus, by blowing airflow from a direction orthogonal to the faces (i.e., from the thickness direction), the airflow passes through the tubes and fins, which results in effective cooling. Therefore, when both faces of the radiator core orthogonal to the thickness direction are heat-transfer surfaces, the horizontal disposition of the radiator means that the heat-transfer surfaces of the radiator are horizontally disposed.

The radiator fan 43 is horizontally disposed above the radiator 42. The horizontal disposition of the radiator fan is defined that the radiator fan is disposed so that the rotational shaft of the fan is along the vertical direction. In the radiator/exhaust chamber 6, there is a space below the radiator 42. In the front surface 2a, a back surface 2b and the side surface 2c (outer plate) of the package, which are respectively the sides of the space, the radiator ventilation holes 42a , 42b and 42c (vent holes) are respectively formed. That is, the radiator ventilation holes 42a, 42b and 42c are formed in the outer plate of the upper structure 30 as the upper section so as to be located lower than the position of the radiator 42.

Like this, since the radiator 42 and the radiator fan 43 are horizontally disposed and furthermore the radiator fan 43 is disposed above the radiator 42, it is possible to pass airflow generated by the radiator fan 43 effectively through the tubes and fins of the radiator 42. The airflow that passed through the radiator 42 is discharged to the outside of the package 2 from the space below the radiator 42 via the radiator ventilation holes 42a, 42b and 42c.

As described above, in the configuration of the radiator/exhaust chamber 6 according to this embodiment, the radiator 42 is horizontally disposed in the upper section, and the radiator fan 43 is horizontally disposed above the radiator 42. Since the radiator fan 43 is disposed above the heat-transfer surfaces of the radiator 42, it is possible to avoid exposure of the fins of the radiator 42 to the outside. Thus, it is possible to resolve the conventional problems that the fins of the radiator 42 are damaged by hailstones or other falling matters and that the appearance is degraded.

Also, in the cogeneration system 1, the outer plate and the supports that make up of the package 2 can be divided into upper parts and lower parts corresponding to the upper section and the lower section. Thus, the upper structure 30, which is the upper section, can be separated from the lower section. Also, the radiator 42 and the radiator fan 43 are supported by the supports in the upper section. In this case, it is also possible to divide/connect piping and wiring such as piping of the cooling water and wiring of the electrical system, which are needed to be communicated or connected between the upper section and the lower section.

Since the cogeneration system 1 has a configuration in which the upper section and the lower section can be separated from each other, the cogeneration system 1 may be easily carried into a building or an apartment building. When the cogeneration system 1 is installed in a building or an apartment building, a rooftop is often chosen as an installation site. Since the size of the cogeneration system 1 can be reduced in the height direction by dividing it into the upper section and the lower section, it is easy to transport the system by an elevator. The transport by an elevator saves time and cost compared to the transport by a crane, which brings benefits to a user.

The present invention may be embodied in other forms without departing from the gist or essential characteristics thereof. The foregoing embodiments are therefore to be considered in all respects as illustrative and not limiting. The scope of the invention is indicated by the appended claims rather than by the foregoing description, and all modifications and changes that come within the meaning and range of equivalency of the claims are intended to be embraced therein.

This application claims priority based on Patent Application No. 2014-063049 filed in Japan on Mar. 26, 2014. The entire contents thereof are hereby incorporated in this application by reference.

### DESCRIPTION OF REFERENCE NUMERALS

1 Cogeneration system (package-storage type engine generator)
2 Package
3 Engine chamber (lower section)
4 Device housing chamber (lower section)
5 Intake chamber (upper section)
6 Radiator/exhaust chamber (upper section)
11 Engine
12 Generator
30 Upper structure (upper section)
31 Frame body
32 Upper/lower partition member
33, 34 Front/rear horizontal member
35 Support member
36 Intermediate support
37 Partition wall
42 Radiator
43 Radiator fan
42a, 42b, 42c Radiator ventilation hole (vent hole)

1. A package-storage type engine generator comprising: a package partitioned into an upper section and a lower section; an engine and a generator both disposed in the lower section; and a radiator and a radiator fan both disposed in the upper section,
wherein the radiator is horizontally disposed in the upper section so that heat-transfer surfaces of the radiator are horizontal,
wherein the radiator fan is disposed above the radiator, and
wherein vent holes are formed in an outer plate of the upper section so as to be located lower than a position of the radiator,
wherein a reserve coolant tank, which is configured to supply a cooling water to an engine coolant circuit, is disposed on a first side of the package in a short-side direction and in a position displaced from the radiator fan in a long-side direction of the package,
wherein an exhaust silencer of the engine is disposed on a second side of the package in the short-side direction, and
wherein a ventilation hole, which is configured to communicate the upper section with the lower section, is formed between the reserve coolant tank and the exhaust silencer, and a ventilation hood is disposed above the ventilation hole.

2. The package-storage type engine generator according to claim 1, wherein the outer plate and supports that make up of the package are dividable into upper parts and lower parts corresponding to the upper section and the lower section, and
wherein the radiator and the radiator fan are supported by the supports in the upper section.
